(19) United States
(12) Patent Application Publication
(10) Pub. No.: US 2023/0291444 A1
(43) Pub. Date: Sep. 14, 2023

(54) METHODS, RADIO ACCESS NETWORK NODE AND WIRELESS DEVICE FOR HANDLING BEAMFORMING IN A WIRELESS COMMUNICATION NETWORK

(71) Applicant: Telefonaktiebolaget LM Ericsson (publ), Stockholm (SE)

(72) Inventor: Sairamesh Nammi, KISTA (SE)

(21) Appl. No.: 18/013,980

(22) PCT Filed: Jul. 10, 2020
(86) PCT No.: PCT/SE2020/050727

§ 371 Date: Dec. 30, 2022

(51) Int. Cl. H04B 7/0452; H04B 7/0417; H04B 7/06

(52) U.S. Cl. CPC H04B 7/0452; H04B 7/0417; H04B 7/0617; H04B 7/0632

(57) ABSTRACT

Disclosed is a method performed by a RAN node of a wireless communication network for directing wireless signals towards wireless devices, the RAN node comprising multiple antennas. The method comprises transmitting, towards the wireless devices and through the multiple antennas, at least a first and a second set of reference signals having mutually different elevation beamforming weights for different elevation transmission directions, wherein elevation transmission direction signifies transmission at an elevation angle towards a horizontal direction. The method further comprises receiving, from the wireless devices, information on channel quality of the at least first and second set of reference signals, determining, based on the received information on channel quality, elevation beamforming weights for a selected transmission elevation angle for the wireless devices; and transmitting data towards the wireless devices in an elevation transmission direction corresponding to the selected transmission elevation angle using the determined elevation beamforming weights.

### TECHNICAL FIELD

The present disclosure relates generally to methods, radio access network (RAN) nodes and wireless devices for handling beamforming in a wireless communication network. The present disclosure also relates to methods, RAN nodes and wireless devices for directing or receiving wireless signals, wherein the RAN node comprises multiple antennas. The present disclosure further relates to computer programs and carriers corresponding to the above methods, devices and nodes.

### BACKGROUND

To meet the huge demand for higher bandwidth, higher data rates and higher network capacity, due to e.g. data centric applications, existing 4^{th} Generation (4G) wireless communication network technology, aka Long Term Evolution (LTE) is being extended or enhanced into a 5^{th} Generation (5G) technology, also called New Radio (NR) access. The following are requirements for 5G wireless communication networks:
Data rates of several tens of megabits per second should be supported for tens of thousands of users;
1 gigabit per second is to be offered simultaneously to tens of workers on the same office floor;
Several hundreds of thousands of simultaneous connections is to be supported for massive sensor deployments;
Spectral efficiency should be significantly enhanced compared to 4G;
Coverage should be improved;
Signaling efficiency should be enhanced; and
Latency should be reduced significantly compared to 4G.

Multiple Input Multiple Output (MIMO) is a method for multiplying the data carrying capacity of a radio link using multiple transmission and receiving antennas at the RAN node and possibly also at the wireless device to exploit multipath propagation. For these reasons, MIMO is an integral part of the 3^{rd} generation (3G) and 4G wireless communication networks. 5G networks will also employ MIMO. Here it may be called massive MIMO systems as there may be hundreds of antennas at the transmitter side and/or the receiver side of the RAN node. Typically, with a (Nₜ, Nᵣ), where Nₜ denotes the number of transmitter antennas and Nᵣ denotes the number of receiver antennas, the peak data rate multiplies with a factor of Nₜ over single antenna systems in a rich scattering environment.

FIG. 1 shows a typical message sequence chart for downlink (DL) data transfer, i.e. from a RAN node to a wireless device, called gNode B (gNB) 30 and User Equipment (UE) 40, respectively, in 5G networks. The gNB 30 transmits 1.1 a DL pilot signal or reference signal, which may be a cell-specific or UE-specific signal. When receiving the pilot or referee signal, the UE 40 computes channel estimates, i.e. estimations of the communication path between the gNB 30 and the UE 40. The channel estimates may be based on signal strength measurements. From the channel estimates, the UE 40 computes 1.2 Channel State Information (CSI) parameters reflecting the state of the communication channel. The UE 40 then sends 1.3 a CSI report comprising the CSI parameters to the gNB 30 via a feedback channel, which may be an uplink control channel. The CSI report is sent either on request from the gNB or periodically. The CSI parameters comprises for example channel quality indicator (CQI), precoding matrix index (PMI), rank information (RI) Channel State Information Reference Signal (CSI-RS) Resource Indicator (CRI). The CRI can be seen as a beam indicator. A network scheduler in the gNB 30 uses this information for choosing or determining 1.4 scheduling parameters for DL transmission for this particular UE 40. The scheduling parameters may comprise Modulation and Coding Scheme (MCS), Transmission Power, Physical Resource Blocks (PRBs) to be used for the following data traffic transmission to the UE 40. The gNB 30 then sends 1.5 the scheduling parameters to the UE 50 in a downlink control channel. After that actual data transfer 1.6 takes place from the gNB 30 to the UE 40 over a traffic channel.

DL reference signals are predefined signals occupying specific resource elements within a downlink time—frequency grid. There are several types of downlink reference signals that are transmitted in different ways and used for different purposes by the receiving terminal, for example:
CSI reference signals (CSI-RS): These reference signals are specifically intended to be used by UEs to acquire channel-state information (CSI) and beam specific information such as beam Reference Signal Received Power (RSRP). In 5G, CSI-RS is UE-specific so it can have a significantly lower time/frequency density than a cell specific reference signal used in 4G, and
Demodulation reference signals (DM-RS): These reference signals also sometimes referred to as UE-specific reference signals, are specifically intended to be used by UEs for channel estimation for a data channel. The label “UE-specific” relates to the fact that each DM-RS is intended for channel estimation by a single UE. That specific reference signal is then only transmitted within the resource blocks assigned for data traffic channel transmission to that UE.

As mentioned, the downlink control channel carries downlink control information (DCI) such as scheduling parameters. Typically, the DCI comprises number of MIMO layers scheduled, transport block sizes, modulation for each codeword, parameters related to Hybrid Automatic Repeat Request (HARQ), sub band locations and also Precoding Matrix Indicator (PMI) corresponding to that sub bands. Note that all DCI formats may not transmit all the information as shown above, in general the contents of the downlink control channel depend on transmission mode and DCI format.

FIG. 2 shows a schematic block diagram of a distributed base station system, in which functionality of a base station, e.g. a gNB, is split in three blocks or units. The three blocks or units are: a baseband unit 50, which performs the physical and medium access control functions within a baseband frequency range; a radio unit 60, which converts the baseband signals from baseband frequency to radio frequency signals for transmission; and an antenna unit 70 through which the radio frequency signals are transmitted.

FIG. 3 shows an example of the distributed base station of FIG. 2 in more detail. In the baseband unit 50, incoming input bits are passed through a forward error correction (FEC)/matching unit 51 where additional parity bits are added for error protection. The resultant bits are then passed through a scrambling unit 52 that adds cell specific scrambling operations for interference avoidance from neighboring cells. The resultant bits are then passed through a modulator 53 that converts the bit stream to complex symbols. The resultant symbols are passed through a layer mapping unit 54 that maps the resultant modulated symbols to different user layers. The resultant symbols per layer are fed through a baseband precoder 55 where they are multiplied with precoding coefficients. Thereafter the resultant symbols are fed through a resource element (RE) mapping unit 56 that maps the symbols to REs assigned to the user. In some cases, when a number of CSI-RS ports are less than the antenna elements, the resultant complex symbols are multiplied by a digital beamforming (DBF) unit 57, which is also called port expansion, where the resultant bits are mapped to the number of antenna elements of the gNB. The mapped resultant bits are then sent to the radio unit 60, as one signal per antenna element. Note that both precoding and digital beamforming are done in frequency domain.

In the radio unit 60, the resultant bit streams are passed through an inverse fast Fourier transform (IFFT) block 61 for converting from frequency domain to time domain. Note that an IFFT block 61 is applied for each antenna element. That is, if we for example have 64 Transmit and Receive (TR) antenna elements, we need to have 64 IFFT blocks. At the IFFT block 61, also a cyclic prefix (CP) may be added. The resultant time domain signals per each TR are passed through a Digital to Analog converter (DAC) 62 for converting to analog domain. The resultant analog signal is multiplied by the analog signal generated from a local oscillator (LO) 63 and passed through a power amplifier (PA) 64 for amplification. The resultant signal is passed through to the antenna unit 70, the antenna unit comprising a number of antenna elements. However, in practice there is often an Analog phase shifting network (APS) 65 arranged between the PA 64 and the antennas 70 which applies cell specific tilts to the transmitted signal for better coverage.

In Active antenna systems (AAS) or active-array-antenna systems, which may be used in a distributed base station system of FIGS. 2 and 3, Radio Frequency (RF) components such as power amplifiers and transceivers are integrated with an array of antennas elements. The AAS offers several benefits compared to traditional passive antenna array systems deployments with passive antennas connected to transceivers through feeder cables. In a passive antennas array system, the baseband signals are boosted by power amplifiers and connected to the antennas by longer feedback cables. By using AAS, not only are cable losses reduced, leading to improved performance and reduced energy consumption, but also is the installation simplified and the required equipment space is reduced.

There are many applications of AAS, for example cell specific beamforming, user specific beamforming, vertical sectorization, massive MIMO, elevation beamforming, hybrid beamforming etc. AAS may also be an enabler for further-advanced antenna concepts such as deploying large number of MIMO antenna elements at the gNB, also called massive MIMO. In massive MIMO systems, optimal performance is obtained with full digital beamforming, that is, each antenna element has separate RF circuitry supporting an independent digital signal definition to each antenna branch. However, when using such a massive MIMO with full digital beamforming providing independent signal paths between the radio unit 60 and the antennas 70, the cost, size, weight and power consumption will be driven up. For example, with full digital beamforming in frequency domain over higher bandwidths, e.g. over 100 MHZ, and hundreds of antenna elements, huge signaling interface bandwidth for transmitting a baseband signal to RF circuitry will be required, as one signal per antenna is needed to be sent over the interface between the baseband unit 50 and the radio unit 60. In addition, each antenna would need separate RF circuitry which is expensive. Also, the power consumption will be very high as one DAC 61 and one PA 64 is needed for each antenna, see FIG. 3.

Hence, an alternative architecture using time domain digital beamforming is preferred for deploying low cost solution of AAS. This architecture is at least partly described in FIG. 4 In time domain digital beamforming, the analogue phase shifting network (APS) 65 is replaced with a digital phase shifting network aka a time domain digital beamforming (TDBF) unit 66 situated at the radio unit 60. Such a TDBF unit 66 is then situated after the IFFT block 61 but before the DAC 62 at the radio unit 60. Consequently, at the TDBF unit 66, common beamforming weights are applied after the IFFT operation. Hereby, one common signal for all antenna elements is sent from the baseband unit to the radio unit. Thereby, interface bandwidth between the baseband unit 50 and the radio unit 60 is lowered quite a lot compared to frequency domain digital beamforming where one signal is sent per antenna element over the interface between baseband and radio unit. Also, the APS 65 can be avoided as the radio unit 60 can control the user specific tilts.

FIG. 5 shows the average sector throughput with different loading conditions for frequency domain, aka full, digital beamforming of FIG. 3 and the alternate architecture of time domain digital beamforming of FIG. 4. As can be seen in FIG. 5, the performance of time domain digital beamforming is poor compared to that of frequency domain digital beamforming. The performance impact is around 10% worse with full load.

FIG. 6 shows average cell edge user throughput with full digital beamforming and with time domain digital beamforming. In this case too, the time domain digital beamforming performs worse compared to that of full digital beamforming, about 20% worse with full load. Hence an efficient solution is needed to improve the performance of time domain digital beamforming. Also, a solution is need that keeps the signaling bandwidth usage down over the interface between the radio unit and the baseband unit.

### SUMMARY

It is an object of the invention to address at least some of the problems and issues outlined above. It is possible to achieve these objects and others by using methods, network nodes and wireless communication devices as defined in the attached independent claims.

According to one aspect, a method is provided that is performed by a RAN node of a wireless communication network for directing wireless signals towards a number of wireless devices, the RAN node comprising multiple antennas. The method comprises transmitting, towards the number of wireless devices and through the multiple antennas, at least a first set of reference signals and a second set of reference signals, the first and second set of reference signals having mutually different elevation beamforming weights for different elevation transmission directions, wherein elevation transmission direction signifies transmission at an elevation angle towards a horizontal direction, which elevation angle is different from zero. The method further comprises receiving, from the number of wireless devices, information on channel quality of the at least first and second set of reference signals, determining, based on the received information on channel quality, elevation beamforming weights for a selected transmission elevation angle for the number of wireless devices, and transmitting data towards the number of wireless devices in an elevation transmission direction corresponding to the selected transmission elevation angle using the determined elevation beamforming weights.

According to another aspect, a method performed by a wireless device of a wireless communication network for receiving wireless signals from a RAN node comprising multiple antennas. The method comprises receiving, from the RAN node, at least a first set of reference signals and a second set of reference signals, the first and second set of reference signals having mutually different elevation beamforming weights for different elevation transmission directions, wherein elevation transmission direction signifies transmission at an elevation angle towards a horizontal direction, which elevation angle is different from zero, determining channel quality of the at least first and second set of reference signals, transmitting, to the RAN node, information on the determined channel quality of the at least first and second set of reference signals, and receiving data from the RAN node, the data being received from the RAN node in an elevation transmission direction corresponding to an elevation transmission angle based on the transmitted information on channel quality of the at least first and second set of reference signals.

According to another aspect, a RAN node is provided that is operable in a wireless communication network and configured for directing wireless signals towards a number of wireless devices. The RAN node comprises multiple antennas. The RAN node further comprises a processing circuitry and a memory. Said memory contains instructions executable by said processing circuitry, whereby the RAN node is operative for transmitting, towards the number of wireless devices and through the multiple antennas, at least a first set of reference signals and a second set of reference signals, the first and second set of reference signals having mutually different elevation beamforming weights for different elevation transmission directions, wherein elevation transmission direction signifies transmission at an elevation angle towards a horizontal direction, which elevation angle is different from zero. The RAN node is further operative for receiving, from the number of wireless devices, information on channel quality of the at least first and second set of reference signals, determining, based on the received information on channel quality, elevation beamforming weights for a selected transmission elevation angle for the number of wireless devices; and transmitting data towards the number of wireless devices in an elevation transmission direction corresponding to the selected transmission elevation angle using the determined elevation beamforming weights.

According to another aspect, a wireless device is provided that is operable in a wireless communication network and configured for receiving wireless signals from a RAN node comprising multiple antennas. The wireless device comprises a processing circuitry and a memory. Said memory contains instructions executable by said processing circuitry, whereby the wireless device is operative for: receiving, from the RAN node, at least a first set of reference signals and a second set of reference signals, the first and second set of reference signals having mutually different elevation beamforming weights for different elevation transmission directions, wherein elevation transmission direction signifies transmission at an elevation angle towards a horizontal direction, which elevation angle is different from zero. The wireless device is further operative for determining channel quality of the at least first and second set of reference signals; transmitting, to the RAN node, information on the determined channel quality of the at least first and second set of reference signals, and receiving data from the RAN node, the data being received from the RAN node in an elevation transmission direction corresponding to an elevation transmission angle based on the transmitted information on channel quality of the at least first and second set of reference signals.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a signaling diagram of a prior art message sequence between network node and device.

FIG. 2 is a schematic block diagram of a distributed base station in which the present invention may be used.

FIG. 3 is a schematic block diagram in more detail of a distributed base station applying frequency domain digital beamforming according to prior art.

FIG. 4 is a schematic block diagram of a distributed base station applying time domain digital beamforming according to prior art.

FIG. 5 is an x/y-diagram comparing throughput for frequency domain digital beamforming and time domain digital beamforming.

FIG. 6 an x/y-diagram comparing a second throughput for frequency domain digital beamforming and time domain digital beamforming.

FIG. 7 is a schematic block diagram of a wireless communication network in which the embodiments of the present invention may be used.

FIG. 8 is a flow chart illustrating a method performed by a network node, according to possible embodiments.

FIG. 9 is another flow chart illustrating another method performed by a network node, according to possible embodiments.

FIG. 10 is a flow chart illustrating a method performed by a wireless device, according to possible embodiments.

FIG. 11 is another flow chart illustrating another method performed by a wireless device, according to possible embodiments.

FIG. 12 is a flow chart of a method performed by a network node according to possible embodiments.

FIG. 13 is an x/y-diagram illustrating SINR for multiple tilt angles compared to single tilt angle.

FIG. 14 is a signaling diagram according to an embodiment.

FIG. 15 is a signaling diagram according to another embodiment.

FIGS. 16 and 17 are x-y diagrams illustrating throughput for single common tilt angle versus multiple tilt angles.

FIG. 18 is a flow chart illustrating a method according to an embodiment.

FIG. 19 is a block diagram illustrating a network node in more detail, according to further possible embodiments.

FIG. 20 is a block diagram illustrating a wireless device in more detail, according to further possible embodiments.

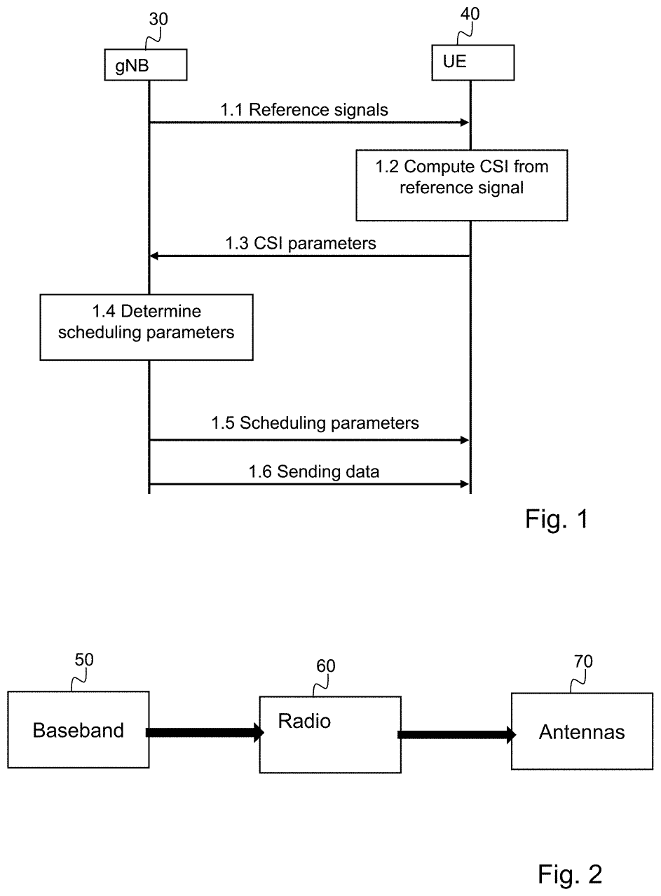

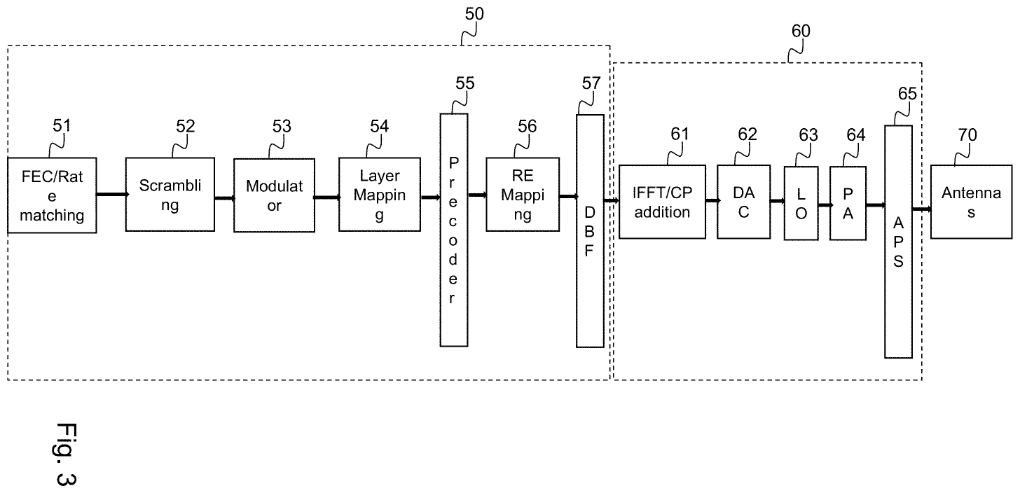

### DETAILED DESCRIPTION

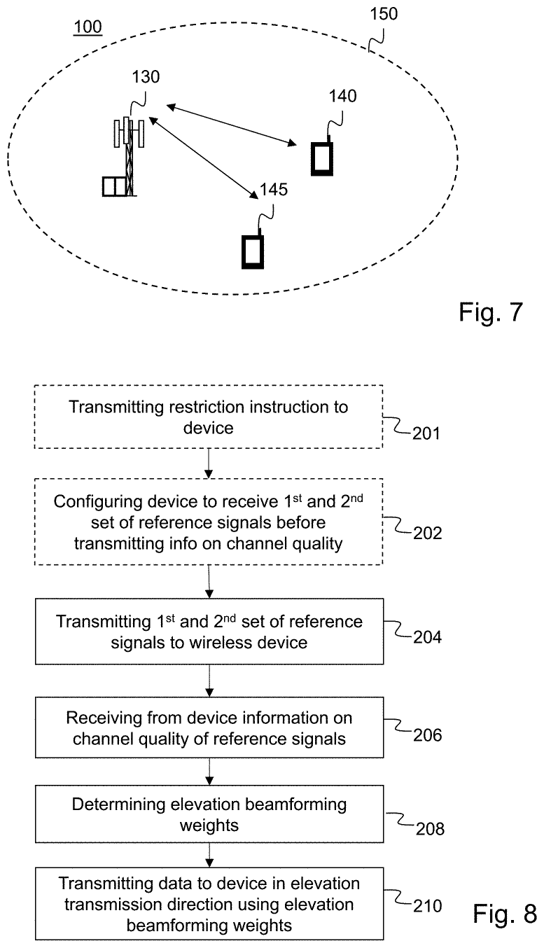

FIG. 7 shows a wireless communication network 100 comprising a RAN node 130 that is in, or is adapted for, wireless communication with a number of wireless devices 140, 145. The RAN node 130 provides radio coverage in a cell 150, which is a geographical area. The number of wireless devices 140, 145 resides in the cell 150.

The wireless communication network 100 may be any kind of wireless communication network that can provide radio access to wireless communication devices. Example of such wireless communication networks are Global System for Mobile communication (GSM), Enhanced Data Rates for GSM Evolution (EDGE), Universal Mobile Telecommunications System (UMTS), Code Division Multiple Access 2000 (CDMA 2000), Long Term Evolution (LTE) Frequency Division Duplex (FDD) and Time Division Duplex (TDD), LTE Advanced, Wireless Local Area Networks (WLAN), Worldwide Interoperability for Microwave Access (WiMAX), WiMAX Advanced, as well as 5G wireless communication networks based on technology such as New Radio (NR). However, the embodiments of the following detailed description are described for NR.

The RAN node 130 may be any kind of network node that provides wireless access to the number of wireless devices 140, 145 alone or in combination with another network node. The RAN node may also be called radio network node or simply network node in this disclosure. Examples of RAN nodes 130 are a base station (BS), a radio BS, a base transceiver station, a BS controller, a network controller, a Node B (NB), an evolved Node B (eNB), a gNodeB (gNB), a Multi-cell/multicast Coordination Entity, a relay node, an access point (AP), a radio AP, a remote radio unit (RRU), a remote radio head (RRH), nodes in a distributed antenna system (DAS) and a multi-standard radio BS (MSR BS).

The number of wireless devices 140, 145 may be any type of device capable of wirelessly communicating with a radio access network node 130 using radio signals. The number of wireless devices may also be called wireless communication device or simply device in this disclosure. For example, the number of wireless devices 140, 145 may be a User Equipment (UE), a machine type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE) etc.

The embodiments described may be applicable to single carrier as well as to multicarrier (MC) or carrier aggregation (CA) operation of the number of wireless devices. The term carrier aggregation (CA) may also be called multi-carrier system, multi-cell operation, multi-carrier operation, and multi-carrier transmission and/or reception. The embodiments may equally apply for Multi radio bearers (RAB) on some carriers, which means that data and speech are simultaneously scheduled.

FIG. 8, in conjunction with FIG. 7, describes a method performed by a RAN node 130 of a wireless communication network 100 for directing wireless signals towards a number of wireless devices 140, the RAN node 130 comprising multiple antennas. The method comprises transmitting 204, towards the number of wireless devices 140 and through the multiple antennas, at least a first set of reference signals and a second set of reference signals, the first and second set of reference signals having mutually different elevation beamforming weights for different elevation transmission directions, wherein elevation transmission direction signifies transmission at an elevation angle towards a horizontal direction, which elevation angle is different from zero. The method further comprises receiving 206, from the number of wireless devices 140, information on channel quality of the at least first and second set of reference signals, determining 208, based on the received information on channel quality, elevation beamforming weights for a selected transmission elevation angle for the number of wireless devices 140, and transmitting 210 data towards the number of wireless devices 140 in an elevation transmission direction corresponding to the selected transmission elevation angle using the determined elevation beamforming weights.

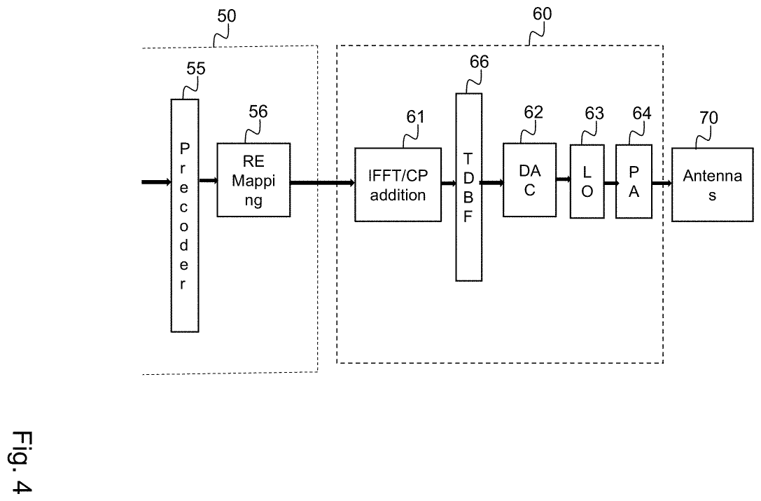

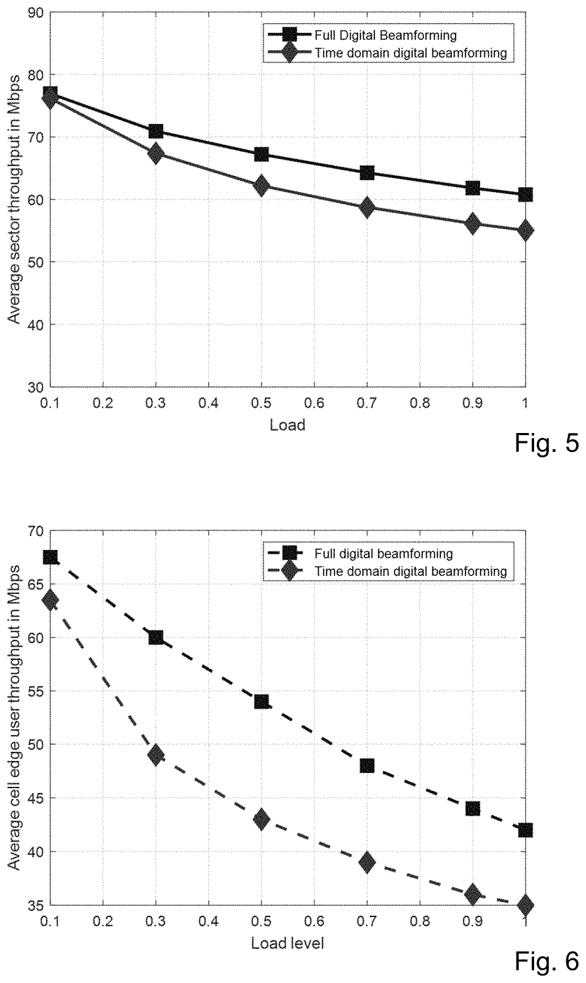

By such a method, not just the direction in terms of azimuth angle that the wireless device is situated in in relation to the RAN node is taken into consideration, as in known time domain beamforming for RAN nodes having multiple antennas, such as in FIG. 4, but also the direction in terms of elevation angle. Consequently, the transmission of data towards the wireless device is beamformed in three dimensions, horizontally and vertically. As a result, a better performance is achieved as the sent data can be received at the wireless device with higher quality and/or sent with lower power compared to if only horizontal beamforming is used and the device is situated so that it has an elevation angle differing from zero. In other words, the performance of time domain digital beamforming as shown in FIG. 4 is improved. Also, as a result an efficient usage of transmission resources is achieved. Also, by using such three-dimensional beamforming, heavy antenna tilting networks are avoided.

The first set of reference signals has a first set of elevation beamforming weights which results in that the first set of reference signals is concentrated into a first elevation transmission direction resembling a first elevation angle. The second set of reference signals has a second set of elevation beamforming weights which results in that the second set of reference signals is concentrated into a second elevation transmission direction resembling a second elevation angle, the first and the second elevation angle being different. There may be more than two sets of reference signals directed in mutually different elevation transmission directions. The information on channel quality may be one or more of CRI, CQI, PMI and RI. The information on channel quality that the RAN node receives from the number of wireless devices is information on channel quality of the at least first and second set of reference signals as the reference signals are received at the number of wireless devices. The number of wireless devices determines the information on channel quality from measurements on the received first and second sets of reference signals. The measurements may be signal strength measurements. In “elevation beamforming weights” both elevation angle and azimuth angle are taken into consideration compared to normal time domain beamforming that only takes azimuth angle into consideration. “Elevation beam forming weights” may also be called three-dimensional time domain beamforming weights. The selected transmission elevation angle may be the same angle as used for the first or second set of reference signals or any other elevation angle determined to be better, based on the first and second set of reference signals, for example an angle in between the elevation angles used for the first and second set of reference signals.

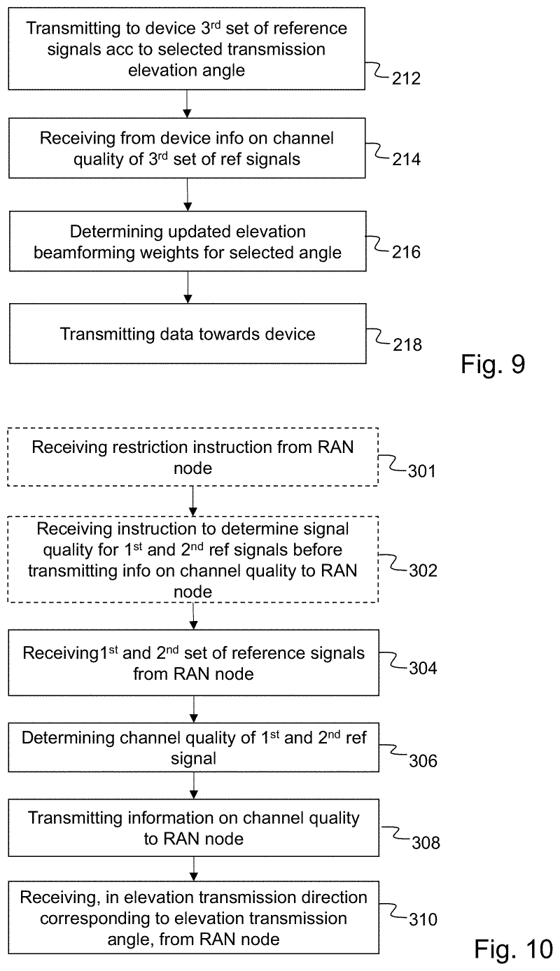

According to an embodiment, which is described in FIG. 9, the method further comprises transmitting 212, towards the number of wireless devices 140 through the multiple antennas, a third set of reference signals, the third set of reference signals being transmitted in the elevation transmission direction corresponding to the selected transmission elevation angle, receiving 214, from the number of wireless devices 140, information on channel quality of the third set of reference signals, determining 216, based on the received information on channel quality of the third set of reference signals, updated elevation beamforming weights for the selected transmission elevation angle, and transmitting 218 data towards the number of wireless devices 140 in the elevation direction corresponding to the selected transmission elevation angle using the determined updated elevation beamforming weights.

By such an update, the method takes into consideration whether the number of wireless devices has moved horizontally since the original determination of elevation beamforming weights as described above and in claim 1. Statistics have shown that number of wireless devices tend to move more often in the horizontal direction than in the vertical direction. In other words, it is more often so that a number of wireless devices stays in one altitude and moves around on that altitude than that the number of wireless devices changes altitude. Therefore, to update the azimuth angle, i.e. to update the beamforming weights but use the same elevation angle would result in efficient usage of transmission resources but still most often result in good data reception quality at the number of wireless devices.

According to an alternative of the latest embodiment, the third set of reference signals are transmitted 212 more often than the first and second set of reference signals, and optionally determining how often the third set of reference signals are to be transmitted compared to how often the first and second set of reference signals are to be transmitted based on the selected transmission elevation angle. For example, when the number of wireless devices is located substantially horizontal to the RAN node, i.e. when the selected transmission elevation angle is zero or close to zero, the first and second set of reference signals are sent less frequently than the third set of reference signals compared to when the selected transmission elevation angle is not close to zero. There may be an elevation angle threshold set at a certain degree and when selected transmission elevation angle is below the elevation angle threshold the first and second set of reference signals are sent less frequency compared to the third set of reference signals compared to when the selected transmission elevation angle is on or above the elevation angle threshold. This embodiment is based on the knowledge that a wireless device that has an elevation angle compared to the RAN node is more probable to change elevation angle than a wireless device that has an elevation angle close to zero.

According to another embodiment shown in FIG. 8, the method further comprises transmitting 201, to the number of wireless devices 140, a restriction instruction instructing the number of wireless devices to determine the information on channel quality from only one of the first and the second set of reference signals at a time and to transmit to the RAN node the information on channel quality of the first set of reference signals separate from the information on channel quality of the second set of reference signals. In other words, such a restriction instruction instructs the number of wireless devices to determine channel quality of one of the first and second sets of reference signals at a time and to transmit to the RAN node the information on the determined channel quality for one of the first and second sets separate from each other. The RAN node may select the one of the first and second set of reference signals that has the highest channel quality and select elevation angle and beamforming weights corresponding to that. The transmitted 201 instructions to determine the information on channel quality for only one set of reference signals at a time may be sent as an RRC signaling in CSI-ReportConfig by setting a flag at 1. The flag may be a timeRestrictonForChannelMeasurement in NR. After having determined 208 the elevation beamforming weights, the RAN node may send another message to the number of wireless devices inhibiting the restriction instruction, e.g. by setting the flag mentioned above to 0. By the RAN node instructing the number of wireless devices to determine the information on channel quality one at a time and to send the information separately, the RAN node will select which of the first and second set of reference signals to use from the received information and choose the beamforming weights from a single channel quality report.

According to another embodiment shown in FIG. 8, the method further comprises configuring 202 the number of wireless devices 140 to receive both the first and the second set of reference signals before the number of wireless devices is to transmit the information on channel quality of the at least first and second set of reference signals to the RAN node. Hereby the first and second set of reference signals can be transmitted to the UE simultaneously or with a short time interval whereby the beamforming weights can be determined very fast. This embodiment is particularly suitable for delay sensitive applications.

According to an alternative of the latest embodiment, the configuring 202 comprises instructing the number of wireless devices 140 to determine which one of the first and second set of reference signals that has the best channel quality, and wherein the received 206 information on channel quality is an indication of the selected transmission elevation angle based on the determination which one of the first and second set of reference signals that has the best channel quality. Here the wireless device is instructed to determine the best elevation angle for transmission to the wireless device and the RAN node only determines the beamforming weights for the selected transmission elevation angle.

According to another embodiment, the method further comprises selecting the transmission elevation angle for the number of wireless devices 140 based on the received information on channel quality of the at least first and second set of reference signals.

According to another embodiment, the number of wireless devices comprises a plurality of wireless devices 140, 145. The method then further comprises obtaining transmission elevation angles for individual of the plurality of wireless devices 140, 145 based on the received 206 information on channel quality of the at least first and second set of reference signals. Also, the determining 208 of elevation beamforming weights comprises determining elevation beamforming weights for a transmission elevation angle range covering the transmission elevation angles of the individual of the plurality of wireless devices. Further, the transmitting 210 of data comprises transmitting of data towards the plurality of wireless devices 140, 145 in the same time-frequency resource in an elevation transmission direction corresponding to the transmission elevation angle range using the determined elevation beamforming weights. To determine elevation beamforming weights for a transmission elevation angle range covering the obtained transmission elevation angles of the individual wireless devices means that elevation beam forming weights are determined for a comparatively broad beam covering the transmission elevation angles of the individual wireless devices so that the data will be transmitted towards the plurality of wireless device in this broad beam using the determined elevation beam forming weights. Hereby it is achieved that more than one wireless device can receive data using the same beam, i.e. the same time-frequency transmission resource. As a result, an efficient usage of transmission resources is achieved.

According to a variant of the above embodiment, the plurality of wireless devices 140, 145 is less than a threshold number. As the method of the above embodiment is especially useful when there are few numbers of UEs to be scheduled in the same time-frequency resource, a threshold number can be set when this method should be used. The threshold could be a pre-defined fixed number or alternatively a dynamic number.

According to another embodiment, the number of wireless devices comprises a plurality of wireless devices 140, 145. Further, the method comprises obtaining transmission elevation angles for individual of the plurality of wireless devices based on the received 206 information on channel quality of the at least first and second set of reference signals, and grouping the plurality of wireless devices into at least a first group and a second group depending on their obtained individual transmission elevation angles. Further, the determining 208 of elevation beamforming weights comprises determining first elevation beamforming weights for a selected first transmission elevation angle for the first group and determining second elevation beamforming weights for a selected second transmission elevation angle for the second group. Still further, the transmitting 210 of data comprises transmitting of data towards the first group of wireless devices in a first time-frequency resource in an elevation transmission direction corresponding to the first transmission elevation angle using the determined first elevation beamforming weights, and transmitting of data towards the second group of wireless devices in a second time-frequency resource in an elevation transmission direction corresponding to the second transmission elevation angle using the determined second elevation beamforming weights. The grouping is performed so that wireless devices with similar transmission elevation angles are grouped together. To group the wireless devices into at least two different groups depending on transmission elevation angle for the individual device and to then determine elevation beamforming weights separately for the different groups and transmit in separate transmission resources (i.e. time-frequency resources) for the different groups means that data is transmitted in two different beams and the beams can be determined to be directed to the groups of devices. Hereby it is achieved that wireless devices having similar transmission elevation angle can receive data using the same beam, i.e. the same time-frequency transmission resource. As a result, an efficient usage of transmission resources is achieved.

According to a variant of this embodiment, the plurality of wireless devices is the same or more than a threshold number. As the method of the above embodiment is especially useful when there are many numbers of UEs to be scheduled in the cell, a threshold number can be set when this method should be used. The threshold could be a pre-defined fixed number or alternatively a dynamic number.

FIG. 10, in conjunction with FIG. 7, describes a method performed by a wireless device 140 of a wireless communication network 100 for receiving wireless signals from a RAN node 130 comprising multiple antennas. The method comprises receiving 304, from the RAN node 130, at least a first set of reference signals and a second set of reference signals, the first and second set of reference signals having mutually different elevation beamforming weights for different elevation transmission directions, wherein elevation transmission direction signifies transmission at an elevation angle towards a horizontal direction, which elevation angle is different from zero, determining 306 channel quality of the at least first and second set of reference signals, transmitting 308, to the RAN node 130, information on the determined channel quality of the at least first and second set of reference signals, and receiving 310 data from the RAN node 130, the data being received from the RAN node in an elevation transmission direction corresponding to an elevation transmission angle based on the transmitted 308 information on channel quality of the at least first and second set of reference signals. As a result, the wireless device will receive the data from the RAN node in a transmission resource efficient way.

According to an embodiment, the information on channel quality of the at least first and second set of reference signals comprises information indicating elevation beamforming weights to be used by the RAN node 130 when transmitting data towards the wireless device 140. The information on channel quality may be for example which of the first or second reference signal that is the best or a suggestion of selected transmission elevation angle that the RAN node should use for determining the beam forming weights.

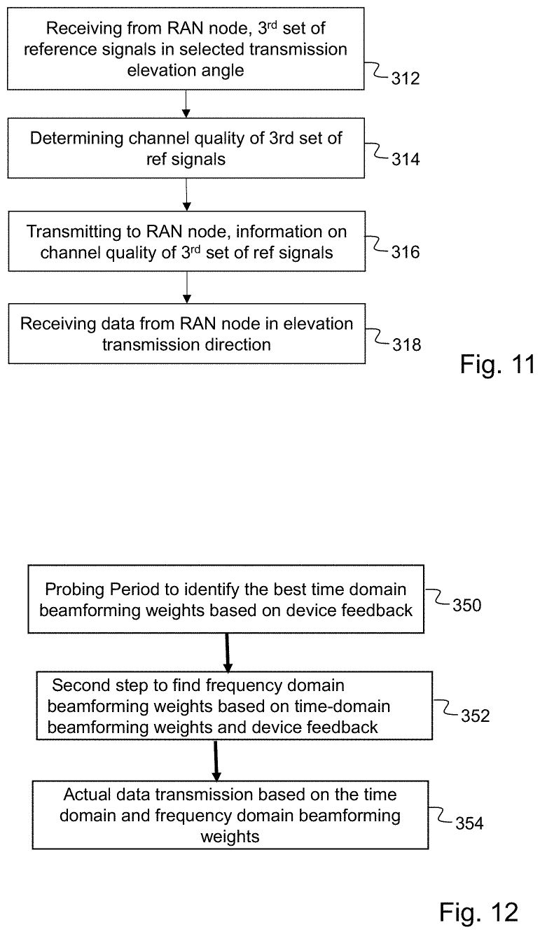

According to an embodiment described in FIG. 11, the method further comprises receiving 312, from the RAN node 130, a third set of reference signals in the elevation transmission direction determined from the transmitted information on channel quality of the at least first and second set of reference signals, determining 314 channel quality of the third set of reference signals, transmitting 316, to the RAN node 130, information on the determined channel quality of the third set of reference signals, and receiving 318 data from the RAN node 130 in the elevation transmission direction. By using such a third set of reference signals, the data sent is directed in a current azimuth direction if the wireless device has moved since the first determination. It is more common that the wireless device moves to change azimuth direction than that it moves to change elevation direction.

According to another embodiment shown in FIG. 10, the method further comprises receiving 301, from the RAN node 130, a restriction instruction to determine the channel quality from only one of the first and the second set of reference signals at a time and to transmit the information on channel quality of the first set of reference signals separate from the information on channel quality of the second set of reference signals.

According to another embodiment shown in FIG. 10, the method further comprises receiving 302, from the RAN node 130, an instruction to receive and determine signal quality for both the first and the second set of reference signals before transmitting the information on the determined channel quality of the at least first and second set of reference signals to the RAN node.

In the following is described methods and arrangements to improve the performance of time domain digital beamforming and at the same time reduce the interface bandwidth between a baseband unit and a radio unit in an embodiment as e.g. in FIG. 4. According to embodiments, the network node probes the device by sending at least a first and a second set of reference signals in mutually different tilt angles aka elevation angles, to detect a specific tilt angle in which the device resides for the moment. Once the network node has identified the specific tilt angle for the device, it schedules the device with the same or a similar tilt angle in the scheduled slot, thereby improving the performance over the known techniques. According to a first embodiment, the network node configures the device to determine information on channel quality from only one of the first and the second set of reference signals at a time and to not average the CSI estimates during the probing period. The device then sends separate CSI reports for the first and second set of reference signals to the network node. According to a second embodiment, the network node configures the device with multiple CSI-RS resources, i.e. configures the device to receive both the first and the second set of reference signals before the device is to transmit the information on channel quality of the at least first and second set of reference signals to the network node. After the first or the second embodiment has been performed the network node computes the Channel capacity from the obtained CSI reports. Thereafter the network node determines the tilt angle for the device and transmits data to the device in the same or a similar tilt angle.

According to an embodiment, which is shown in FIG. 12, a two-step procedure is used by the network node for transmitting data to the device using time domain digital beamforming with elevation beamforming weights. In the first step, the network node determines beamforming weights based on feedback from the device on at least first and second reference signals sets directed in different elevation angles. We call this a probing period 350. Here the tilt angle suitable for the device is determined. In a second step 352, the network node sends a third set of reference signals in the determined tilt angle towards the device, receives device feedback as CSI reporting from the device and determines and updates frequency domain beamforming weights based on the CSI reporting. Actual data transmission 354 is performed based on the elevation beamforming weights. The data transmission may be performed before the second step has been performed but after the second step has been performed the data transmission is performed using the updated elevation beamforming weights. Note that the first step, i.e. the probing period, may be done at regular time intervals with a time period T1, while the second step is performed at a faster rate, with time period T2, where preferably T2<<T1. According to one alternative, the value of T1 is fixed to high value for all devices in a cell as it is rare that devices in elevation angles differing from zero moves very fast. According to another alternative, the value of T1 is determined based on the location of the device. For example, if the device is in horizontal domain, i.e. in an elevation angle below a certain threshold, the value of T1 can be set to low value, and if the device is above the certain elevation angle threshold, the value of T1 can be set to a value that is higher than the low value. Note that, the network node can get the device location by different methods such as Global Positioning System (GPS), mobile positioning etc. The network node can also get the device location as a result of the probing period. The device location may then be updated by step 352. Also, T1 may be adapted for subsequent probing steps, depending on device location change.

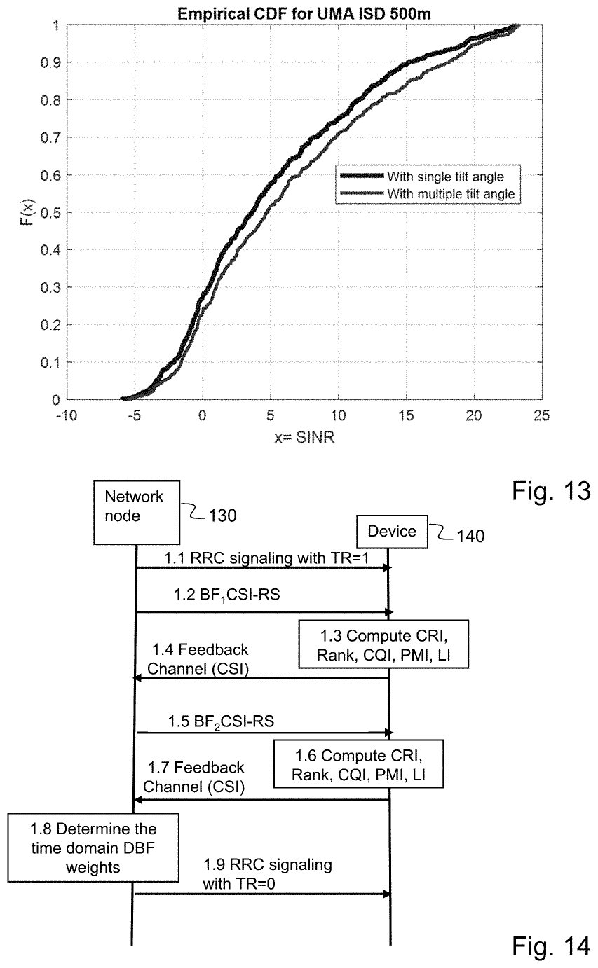

By using the above techniques, the performance of the time domain digital beamforming of FIG. 4 can be improved significantly, which is shown in FIG. 13. FIG. 13 shows the Signal to Interference and Noise Ratio (SINR) Cumulative distribution function (CDF) using single and multiple tilt angles for time domain digital beamforming. Single tilt angle beam forming means that all UEs in the cell receiving data in the same time-frequency resource receive data directed in the same tilt (aka elevation) angle. Multiple tilt angles mean that the UEs has individual elevation beamforming weights depending on their individual elevation angle. It can be observed that the SINR is improved significantly for all the UEs as our method can find an optimal tilt angle for each UE.

FIG. 14 describes an embodiment at the Network Node to compute the elevation beamforming weights based on separately received CSI-RS resource sets. Note that it is needed to identify the device specific tilt angle. In this embodiment, we explain how the network node can compute the elevation beamforming weights based on separately received individual CSI-RS resource sets. Firstly, the network node informs the device to derive information on channel quality i.e. CSI reports (including CSI-RS resource sets) on a received first and a second set of reference signals separately. For this purpose, we may for example use a certain Radio Resource Control (RRC) signaling in the NR specification 3GPP TS 38.214, called timeRestrictionForChannelMeasurements (TR=1) in CSI-ReportConfig., which indicates to the UE that the UE shall derive the channel measurements for computing CSI reported in uplink slot n based on only the most recent CSI-RS. Hereby it is avoided that the device averages the channel measurements from different CSI-RS occasions. A message sequence chart of an example of a proposed algorithm is shown in FIG. 14. The network node 130 sends 1.1. an RRC signaling with Time Restriction (TR)=1, where TR=1 signals to the device that the above-mentioned time restriction applies. The network node then sends 1.2 first set of reference signal using first elevation beamforming weights BF₁CSI-RS directed in a first elevation angle. The device 140 then computes 1.3 channel quality information, i.e. CSI, for the first reference signal. The channel quality information may comprise one or more of CRI, Rank, CQI, PMI and LI. The device sends 1.4 the channel quality information in e.g. a feedback channel to the network node. Thereafter, or at least at a later time than sending the first set of reference signals, the network node sends 1.5 the second set of reference signals using second elevation beamforming weights BF₂CSI-RS directed in a second elevation angle different from the first elevation angle. The device 140 then computes 1.6 channel quality information for the second reference signal such as CRI, Rank, CQI, PMI and LI. The device sends 1.7 the channel quality information, i.e. CSI, in e.g. a feedback channel to the network node. The network node then determines 1.8 the elevation beam forming (DBF) weights to use for transmission of data to the device 140 using the separately received channel quality information on the first and second set of reference signals. Thereafter, the network node may send 1.9 RRC with T=0 to disable the time restriction.

As an example of the embodiment described in FIG. 14, L sets of reference signals are sent individually as in 1.2 and 1.5 of FIG. 14, the sets of reference signals having mutually different elevation beamforming weights for different elevation angles. Further, Rank (R), and CQI corresponding to each CSI report are denoted by Rᵢ and CQIi, where i=1,2 . . . L, then the network node chooses the beamforming vector (reference signal) that maximizes the multiplication operation

L=arg max{R₁CQI₁, R₂CQI₂, . . . R_{L}CQI_{L}}

That is, the network node chooses elevation beamforming weights for the transmission to the device based on the combination of R and CQI that gives the best capacity of the single CSI-RS resource sets.

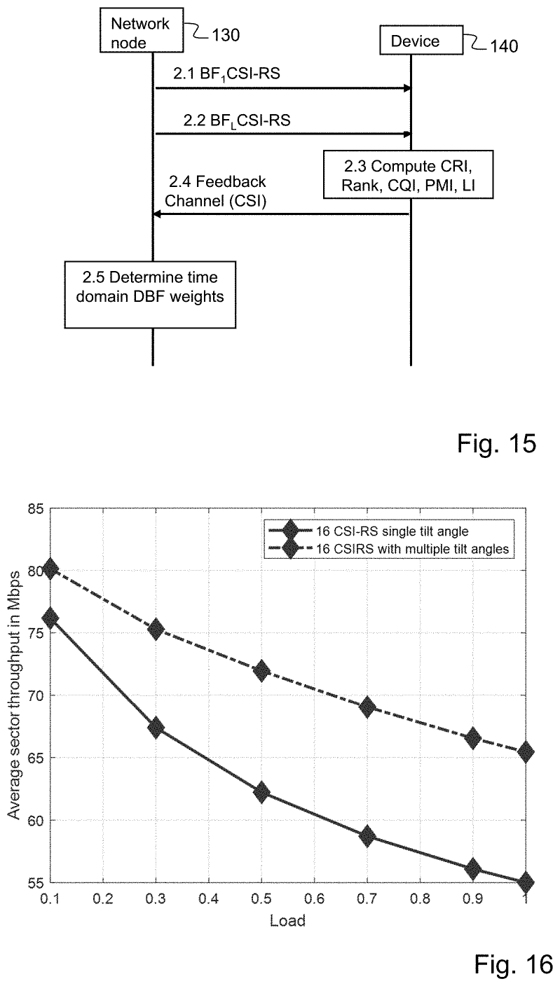

FIG. 15 describes an embodiment at the network node to compute the elevation beamforming weights based on multiple CSI-RS resource sets. Here the network can use multiple CSI-RS resource sets to determine the best elevation beamforming weights by configuring the device to receive multiple sets of reference signals, aka multiple CSI-RS resource sets. A message sequence chart of an example of a proposed algorithm is shown in FIG. 15. The network node 130 sends 2.1 a first set of reference signals using first elevation beamforming weights BF₁CSI-RS directed in a first elevation angle, as well as a second set of reference signals using second elevation beamforming weights BF₂CSI-RS directed in a second elevation angle, up to sending 2.2 the L^{th} set of reference signals using L^{th} elevation beamforming weights BF_{L}CSI-RS directed in an L^{th} elevation angle. The device 140 then computes 2.3 channel quality information for the L set of reference signals, the channel quality information, i.e. CSI, comprising one or more of CRI, Rank, CQI, PMI and LI. The device 140 sends 2.4 the channel quality information in e.g. a feedback channel to the network node. The network node 130 then determines 2.5 the elevation beamforming weights to use for transmission of data to the device 140 using the received channel quality information, which is for the L set of reference signals. Here, the channel quality information sent by the device may indicate the best suitable beamforming matrix to use for the device. An advantage of this embodiment is that all the CSI-RS resource sets can be transmitted simultaneously or with less time intervals, thereby identifying the time domain weights very fast. This embodiment is therefore particularly suitable for delay sensitive applications.

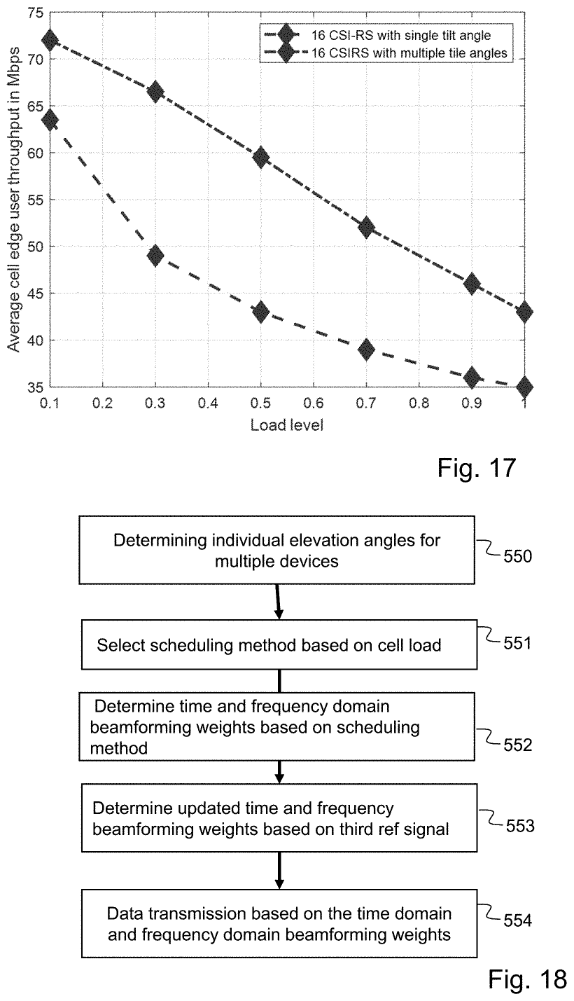

FIGS. 16 and 17 show results when simulating a network when using only one common tilt or elevation angle for all UEs in a cell compared to multiple/individual tilt or elevation angles as in embodiments of the present invention. In the simulation, UEs are randomly positioned such that each has a different tilt angle. As can be seen in FIG. 16, there is a performance improvement of approximately 10-20% throughput when using multiple tilt angles compared to a single tilt angle for average sector throughput, and even more for average cell edge user throughput. Consequently, it can be observed that the throughput improves significantly over the conventional technique.

FIG. 18 describes an embodiment that handles the case where there are multiple devices that are to be scheduled in the same transmission resource(s), i.e. same time-frequency resource(s), and the multiple devices are located at different elevation angles. When comparing the method of FIG. 12 to the method of FIG. 18, the method of FIG. 18 has an extra step 551 of selecting a scheduling method for the devices depending on for example the load of the cell. First, the network node determines 550 individual elevation angles for each of the multiple devices based on feedback from each of the multiple devices on at least first and second reference signals sets directed in different elevation angles. Then a scheduling method or technique is selected 551. The different scheduling methods/techniques and how they are selected will be described in more detail further below. After, the scheduling technique has been selected, elevation beamforming weights 552 are determined according to the selected technique. Thereafter, and similar to the method of FIG. 12, the network node sends a third set of reference signals in the determined tilt angle(s) towards the devices, receives feedback from each of the devices and determines 553 and updates elevation beamforming weights based on the CSI reporting. Actual data transmission 454 is performed based on the elevation beamforming weights. The data transmission may be performed before the step 553 has been performed, but after the step 553 has been performed the data transmission is performed using the updated elevation beamforming weights. Note that 550-552, i.e. the probing period, may be done at regular time intervals with a time period T1, while the second step is performed at a faster rate, with time period T2, where preferably T2<<T1.

As mentioned, when having multiple devices that are to be scheduled in the same transmission resource, different scheduling techniques can be used for determining the most suitable tilt angle to use. This refers to step 551.

According to a first embodiment of a scheduling technique, the network node groups devices belonging to the same or similar tilt angles and schedules them in the same transmission resource. For example, if there are 5 devices: [UE1, UE2, UE3, UE4 and UE5]. Let's say the device specific tilt angles found in section 5.2 are [50 100 50 50 100]. Then UE1, UE3 and UE4 are grouped as one cluster and multiplexed in the same transmission resource, while UE2 and UE5 are grouped as another cluster and are scheduled in another transmission resource.

According to a second embodiment of a scheduling technique, the network node multiplexes devices irrespective of their specific tilt angle. For time domain digital beamforming of FIG. 4, the network node has a constraint that it must schedule with only one tilt angle. In this embodiment, the network node uses a wide beam to serve devices in one transmission resource irrespective of their tilt angle. In another embodiment, the network node can fix the time domain digital beamforming to a specific tilt belonging to a certain device and change the other devices' elevation beamforming weights such that performance impact is minimal. Mathematically this can be explained as follows: Let us say if we are multiplexing two devices: UE1 and UE2 with two different optimum tilt angles, e.g. 5° and 10°. First consider only transmitting to UE1, then the received signal at UE1 is written as

Y₁=H₁P₂FW₁x₁+n₁,

where Y1 is the time domain received signal with dimensions Nr×1, where Nr is number of receiving antenna elements at the UE1, H1 is the Channel matrix with dimensions Nr×Nt matrix, where Nt is the number of transmitting antenna elements at the network node, P₂ is a matrix with time domain digital beamforming weights, F is a Discrete Fourier Transform (DFT) matrix of dimensions N_{L}×N_{L}, W₁ is the equivalent precoding matrix done at the baseband unit, having dimensions N_{L}×R, where R is the transmission rank or number of layers supported by the network, x₁ is the transmitted signal with dimensions R×1, N_{L} is NL-point DFT, for example 1024, or 2048 point DFT, and n₁ is the noise vector of dimensions of Nr×1. Similarly the received signal at the receiver of UE2 is written as

Y₂=H₂P₄FW₂x₂+n₂,

where Y2 is the time domain received signal with dimensions Nr×1, Nr is number of receiving antennas at the UE2, H₂ is the Channel matrix with dimensions Nr×Nt matrix, where Nt is the number of transmitting antenna elements at the network node, P₄ is a matrix with time domain digital beamforming weights, F is the DFT matrix of dimensions N_{L}×N_{L}, W₂ is the equivalent precoding matrix done at the baseband unit, having dimensions NL×R, where R is the transmission rank or number of layers supported by the network, x₂ is the transmitted signal with dimensions R×1 and n₂ is the noise vector of dimensions of Nr×1.

Let us say now that UE1 and UE2 are multiplexed in a transmission resource, i.e. slot, with common tilt angle P2, corresponding to the optimum tilt angle of UE1, then there is no impact to the received signal for UE1, however the received signal at the UE2 is different. To reduce the impact, we can change the beamforming weights in the frequency domain for the UE2. This can mathematically be written as

Y_{2proposed}=H₂P₂FDP₄W₂x₂+n₂,

Where we use the common time domain digital beamforming matrix P₂, P₄ is done in the frequency domain, while the matrix D is chosen such that it will minimize the impact of P₂, thereby minimizing the losses due to the constraint of time domain digital beamforming matrix.

It can be observed that that the two scheduling techniques described above can be used for scheduling when UEs with different optimum tilt angles are multiplexed in a slot. However, the first method, i.e. the grouping of devices with same or similar tilt angle, will perform better when there are a greater number of devices with same or at least very similar tilt angle. That is if the load of the network is very high, then there is a high probability that devices multiplexed in a slot will have the same tilt angle. However, when the load of the cell is not so high, then the second method, i.e. to select a common tilt angle for the devices, will perform better. Consequently, the scheduling method to use of the first or the second method when having a plurality of devices to be scheduled could be selected based on the load of the cell. For example, a load threshold could be set up and the first method can be used when the load in the cell is above the load threshold and the second method can be used when the load in the cell is below the load threshold.

There are different methods to determine the load of the cell. For example, it may be done by noting down the number of devices in RRC connected mode, by determining average number of PRB utilizations over a time period etc.

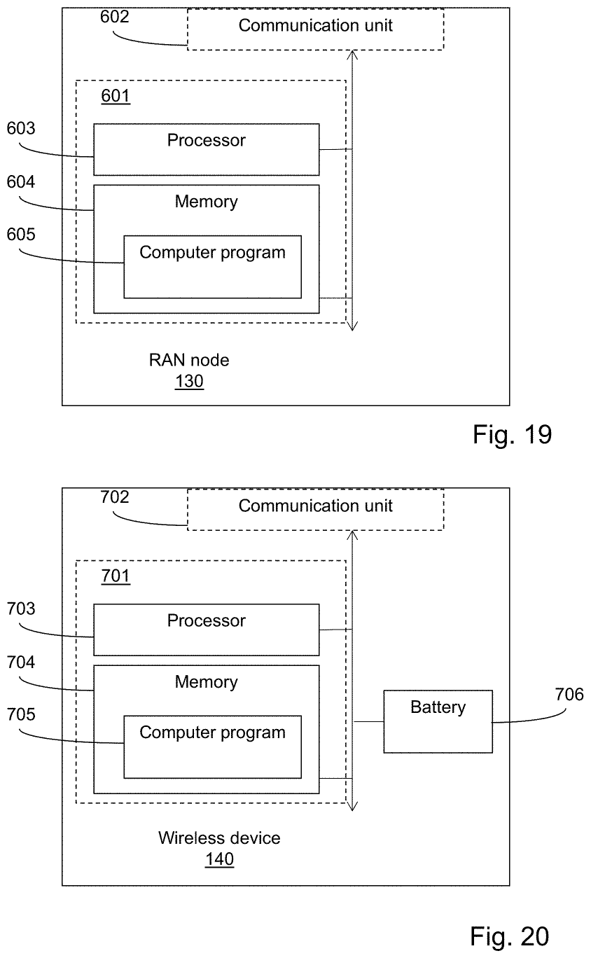

FIG. 19, in conjunction with FIG. 7, describes a RAN node 130 operable in a wireless communication network 100 and configured for directing wireless signals towards a number of wireless devices 140. The RAN node 130 comprises multiple antennas. The RAN node 130 further comprises a processing circuitry 603 and a memory 604. Said memory contains instructions executable by said processing circuitry, whereby the RAN node 130 is operative for transmitting, towards the number of wireless devices 140 and through the multiple antennas, at least a first set of reference signals and a second set of reference signals, the first and second set of reference signals having mutually different elevation beamforming weights for different elevation transmission directions, wherein elevation transmission direction signifies transmission at an elevation angle towards a horizontal direction, which elevation angle is different from zero. The RAN node is further operative for receiving, from the number of wireless devices 140, information on channel quality of the at least first and second set of reference signals, determining, based on the received information on channel quality, elevation beamforming weights for a selected transmission elevation angle for the number of wireless devices; and transmitting data towards the number of wireless devices 140 in an elevation transmission direction corresponding to the selected transmission elevation angle using the determined elevation beamforming weights.

According to an embodiment, the RAN node 130 is further operative for transmitting, towards the number of wireless devices 140 through the multiple antennas, a third set of reference signals, the third set of reference signals being transmitted in the elevation transmission direction corresponding to the selected transmission elevation angle and receiving, from the number of wireless devices 140, information on channel quality of the third set of reference signals. Further, the RAN node is operative for determining, based on the received information on channel quality of the third set of reference signals, updated elevation beamforming weights for the selected transmission elevation angle; and transmitting data towards the number of wireless devices 140 in the elevation direction corresponding to the selected transmission elevation angle using the determined updated elevation beamforming weights.

According to another embodiment, the RAN node 130 is operative for transmitting the third set of reference signals more often than the first and second set of reference signals, and optionally operative for determining how often the third set of reference signals are to be transmitted compared to how often the first and second set of reference signals are to be transmitted based on the selected transmission elevation angle.

According to another embodiment, the RAN node 130 is further operative for transmitting, to the number of wireless devices 140, a restriction instruction instructing the number of wireless devices to determine the information on channel quality from only one of the first and the second set of reference signals at a time and to transmit to the RAN node the information on channel quality of the first set of reference signals separate from the information on channel quality of the second set of reference signals.

According to another embodiment, the RAN node 130 is further operative for configuring the number of wireless devices 140 to receive both the first and the second set of reference signals before the number of wireless devices is to transmit the information on channel quality of the at least first and second set of reference signals to the RAN node.

According to another embodiment, the RAN node 130 is operative for the configuring of the number of wireless devices 140 by instructing the number of wireless devices 140 to determine which one of the first and second set of reference signals that has the best channel quality, and wherein the received information on channel quality is an indication of the selected transmission elevation angle based on the determination which one of the first and second set of reference signals that has the best channel quality.

According to another embodiment, the RAN node 130 is further operative for selecting the transmission elevation angle for the number of wireless devices 140 based on the received information on channel quality of the at least first and second set of reference signals.

According to yet another embodiment, the number of wireless devices comprises a plurality of wireless devices 140, 145. Further, the RAN node 130 is operative for obtaining transmission elevation angles for individual of the plurality of wireless devices 140, 145 based on the received information on channel quality of the at least first and second set of reference signals. Also, the RAN node is operative for determining of the elevation beamforming weights for a transmission elevation angle range covering the transmission elevation angles of the individual of the plurality of wireless devices, and the RAN node is operative for transmitting of data towards the plurality of wireless devices 140, 145 in the same time-frequency resource in an elevation transmission direction corresponding to the transmission elevation angle range using the determined elevation beamforming weights. According to a variant, the plurality of wireless devices 140, 145 is less than a threshold number.

According to yet another embodiment, the number of wireless devices comprises a plurality of wireless devices 140, 145. Further, the RAN node 130 is operative for obtaining transmission elevation angles for individual of the plurality of wireless devices based on the received information on channel quality of the at least first and second set of reference signals, and for grouping the plurality of wireless devices into at least a first group and a second group depending on their obtained individual transmission elevation angles. Further, the RAN node is operative for determining of the elevation beamforming weights for a selected first transmission elevation angle for the first group and for determining second elevation beamforming weights for a selected second transmission elevation angle for the second group. Also, the RAN node is operative for transmitting of data towards the first group of wireless devices in a first time-frequency resource in an elevation transmission direction corresponding to the first transmission elevation angle using the determined first elevation beamforming weights, and for transmitting of data towards the second group of wireless devices in a second time-frequency resource in an elevation transmission direction corresponding to the second transmission elevation angle using the determined second elevation beamforming weights. According to a variant, the plurality of wireless devices 140, 145 is the same or more than a threshold number.

According to other embodiments, the RAN node 130 may further comprise a communication unit 602, which may be considered to comprise conventional means for wireless communication with the wireless device 140, such as a transceiver for wireless transmission and reception of signals. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions.

The computer program 605 may be arranged such that when its instructions are run in the processing circuitry, they cause RAN node 130 to perform the steps described in any of the described embodiments of the RAN node 130 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). In some embodiments, a carrier may contain the computer program 605. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 604. Alternatively, the computer program may be stored on a server or any other entity to which the RAN node 130 has access via the communication unit 602. The computer program 605 may then be downloaded from the server into the memory 604.

FIG. 20, in conjunction with FIG. 7, describes a wireless device 140 operable in a wireless communication network 100 and configured for receiving wireless signals from a RAN node 130 comprising multiple antennas. The wireless device 140 comprises a processing circuitry 703 and a memory 704. Said memory contains instructions executable by said processing circuitry, whereby the wireless device 140 is operative for: receiving, from the RAN node 130, at least a first set of reference signals and a second set of reference signals, the first and second set of reference signals having mutually different elevation beamforming weights for different elevation transmission directions, wherein elevation transmission direction signifies transmission at an elevation angle towards a horizontal direction, which elevation angle is different from zero. The wireless device is further operative for determining channel quality of the at least first and second set of reference signals; transmitting, to the RAN node 130, information on the determined channel quality of the at least first and second set of reference signals, and receiving data from the RAN node 130, the data being received from the RAN node in an elevation transmission direction corresponding to an elevation transmission angle based on the transmitted information on channel quality of the at least first and second set of reference signals.

According to an embodiment, the information on channel quality of the at least first and second set of reference signals comprises information indicating elevation beamforming weights to be used by the RAN node 130 when transmitting data towards the wireless device 140.

According to another embodiment, the wireless device 140 is further operative for receiving, from the RAN node 130, a third set of reference signals in the elevation transmission direction determined from the transmitted information on channel quality of the at least first and second set of reference signals, determining channel quality of the third set of reference signals, transmitting, to the RAN node 130, information on the determined channel quality of the third set of reference signals, and receiving data from the RAN node 130, in the elevation transmission direction.

According to another embodiment, the wireless device 140 is further operative for receiving, from the RAN node 130, a restriction instruction to determine the channel quality from only one of the first and the second set of reference signals at a time and to transmit the information on channel quality of the first set of reference signals separate from the information on channel quality of the second set of reference signals.

According to another embodiment, the wireless device 140 is further operative for receiving, from the RAN node 130, an instruction to receive and determine signal quality for both the first and the second set of reference signals before transmitting the information on the determined channel quality of the at least first and second set of reference signals to the RAN node.

According to other embodiments, the wireless device 140 may further comprise a communication unit 702, which may be considered to comprise conventional means for wireless communication with the RAN node 130, such as a transceiver for wireless transmission and reception of signals. The instructions executable by said processing circuitry 703 may be arranged as a computer program 705 stored e.g. in said memory 704. The processing circuitry 703 and the memory 704 may be arranged in a sub-arrangement 701. The sub-arrangement 701 may be a micro-processor and adequate software and storage therefore, a Programmable Logic Device, PLD, or other electronic component(s)/processing circuit(s) configured to perform the methods mentioned above. The processing circuitry 703 may comprise one or more programmable processor, application-specific integrated circuits, field programmable gate arrays or combinations of these adapted to execute instructions.

The computer program 705 may be arranged such that when its instructions are run in the processing circuitry, they cause wireless device 140 to perform the steps described in any of the described embodiments of the wireless device 140 and its method. The computer program 705 may be carried by a computer program product connectable to the processing circuitry 703. The computer program product may be the memory 704, or at least arranged in the memory. The memory 704 may be realized as for example a RAM (Random-access memory), ROM (Read-Only Memory) or an EEPROM (Electrical Erasable Programmable ROM). In some embodiments, a carrier may contain the computer program 705. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 704. Alternatively, the computer program may be stored on a server or any other entity to which wireless device 140 has access via the communication unit 702. The computer program 705 may then be downloaded from the server into the memory 704.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” Further, the term “a number of”, such as in “a number of wireless devices” signifies one or more devices. All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a radio access network, RAN, node of a wireless communication network for directing wireless signals towards a number of wireless devices, the RAN node comprising multiple antennas, the method comprising:
transmitting, towards the number of wireless devices and through the multiple antennas, at least a first set of reference signals and a second set of reference signals, the first and second set of reference signals having mutually different elevation beamforming weights for different elevation transmission directions, wherein elevation transmission direction signifies transmission at an elevation angle towards a horizontal direction, which elevation angle is different from zero;
receiving, from the number of wireless devices, information on channel quality of the at least first and second set of reference signals;
determining, based on the received information on channel quality, elevation beamforming weights for a selected transmission elevation angle for the number of wireless devices; and
transmitting data towards the number of wireless devices in an elevation transmission direction corresponding to the selected transmission elevation angle using the determined elevation beamforming weights.

2. The method according to claim 1, further comprising:
transmitting, towards the number of wireless devices through the multiple antennas, a third set of reference signals, the third set of reference signals being transmitted in the elevation transmission direction corresponding to the selected transmission elevation angle;
receiving, from the number of wireless devices, information on channel quality of the third set of reference signals;
determining, based on the received information on channel quality of the third set of reference signals, updated elevation beamforming weights for the selected transmission elevation angle; and
transmitting data towards the number of wireless devices in the elevation direction corresponding to the selected transmission elevation angle using the determined updated elevation beamforming weights.

3. The method according to claim 2, wherein the third set of reference signals are transmitted more often than the first and second set of reference signals, and optionally determining how often the third set of reference signals are to be transmitted compared to how often the first and second set of reference signals are to be transmitted based on the selected transmission elevation angle.

4. The method according to claim 1, further comprising:
transmitting, to the number of wireless devices, a restriction instruction instructing the number of wireless devices to determine the information on channel quality from only one of the first and the second set of reference signals at a time and to transmit to the RAN node the information on channel quality of the first set of reference signals separate from the information on channel quality of the second set of reference signals.

5. The method according to claim 1, further comprising:
configuring the number of wireless devices to receive both the first and the second set of reference signals before the number of wireless devices is to transmit the information on channel quality of the at least first and second set of reference signals to the RAN node.

6. The method according to claim 5, wherein the configuring comprises instructing the number of wireless devices to determine which one of the first and second set of reference signals that has the best channel quality, and wherein the received information on channel quality is an indication of the selected transmission elevation angle based on the determination which one of the first and second set of reference signals that has the best channel quality.

7. The method according to claim 1, further comprising:
selecting the transmission elevation angle for the number of wireless devices based on the received information on channel quality of the at least first and second set of reference signals.

8. The method according to claim 1, wherein the number of wireless devices comprises a plurality of wireless devices, the method further comprising:
obtaining transmission elevation angles for individual of the plurality of wireless devices based on the received information on channel quality of the at least first and second set of reference signals,
wherein the determining of elevation beamforming weights comprises determining elevation beamforming weights for a transmission elevation angle range covering the transmission elevation angles of the individual of the plurality of wireless devices, and wherein the transmitting of data comprises transmitting of data towards the plurality of wireless devices in the same time-frequency resource in an elevation transmission direction corresponding to the transmission elevation angle range using the determined elevation beamforming weights.

9. The method according to claim 8, wherein the plurality of wireless devices is less than a threshold number.

10. The method according to claim 1, wherein the number of wireless devices comprises a plurality of wireless devices, the method further comprising:
obtaining transmission elevation angles for individual of the plurality of wireless devices based on the received information on channel quality of the at least first and second set of reference signals; and
grouping the plurality of wireless devices into at least a first group and a second group depending on their obtained individual transmission elevation angles,
wherein the determining of elevation beamforming weights comprises determining first elevation beamforming weights for a selected first transmission elevation angle for the first group and determining second elevation beamforming weights for a selected second transmission elevation angle for the second group,
wherein the transmitting of data comprises transmitting of data towards the first group of wireless devices in a first time-frequency resource in an elevation transmission direction corresponding to the first transmission elevation angle using the determined first elevation beamforming weights, and transmitting of data towards the second group of wireless devices in a second time-frequency resource in an elevation transmission direction corresponding to the second transmission elevation angle using the determined second elevation beamforming weights.

11. The method according to claim 10, wherein the plurality of wireless devices is the same or more than a threshold number.

12. A method performed by a wireless device of a wireless communication network for receiving wireless signals from a RAN node comprising multiple antennas, the method comprising:
receiving, from the RAN node, at least a first set of reference signals and a second set of reference signals, the first and second set of reference signals having mutually different elevation beamforming weights for different elevation transmission directions, wherein elevation transmission direction signifies transmission at an elevation angle towards a horizontal direction, which elevation angle is different from zero;
determining channel quality of the at least first and second set of reference signals;
transmitting, to the RAN node, information on the determined channel quality of the at least first and second set of reference signals; and
receiving data from the RAN node, the data being received from the RAN node in an elevation transmission direction corresponding to an elevation transmission angle based on the transmitted information on channel quality of the at least first and second set of reference signals.

13. The method according to claim 12, wherein the information on channel quality of the at least first and second set of reference signals comprises information indicating elevation beamforming weights to be used by the RAN node when transmitting data towards the wireless device.

14. The method according to claim 12, further comprising:
receiving, from the RAN node, a third set of reference signals in the elevation transmission direction determined from the transmitted information on channel quality of the at least first and second set of reference signals;
determining channel quality of the third set of reference signals;
transmitting, to the RAN node, information on the determined channel quality of the third set of reference signals; and
receiving data from the RAN node, in the elevation transmission direction.

15. The method according to claim 12, further comprising:
receiving, from the RAN node, a restriction instruction to determine the channel quality from only one of the first and the second set of reference signals at a time and to transmit the information on channel quality of the first set of reference signals separate from the information on channel quality of the second set of reference signals.

16. The method according to claim 12, further comprising:
receiving, from the RAN node, an instruction to receive and determine signal quality for both the first and the second set of reference signals before transmitting the information on the determined channel quality of the at least first and second set of reference signals to the RAN node.

17. A RAN node operable in a wireless communication network and configured for directing wireless signals towards a number of wireless devices, the RAN node comprising multiple antennas, the RAN node comprising a processing circuitry and a memory, said memory containing instructions executable by said processing circuitry, whereby the RAN node is operative to:
transmit, towards the number of wireless devices and through the multiple antennas, at least a first set of reference signals and a second set of reference signals, the first and second set of reference signals having mutually different elevation beamforming weights for different elevation transmission directions, wherein elevation transmission direction signifies transmission at an elevation angle towards a horizontal direction, which elevation angle is different from zero;
receive, from the number of wireless devices, information on channel quality of the at least first and second set of reference signals;
determine, based on the received information on channel quality, elevation beamforming weights for a selected transmission elevation angle for the number of wireless devices; and
transmit data towards the number of wireless devices in an elevation transmission direction corresponding to the selected transmission elevation angle using the determined elevation beamforming weights.

18-36. (canceled)
